(19) United States
(12) Patent Application Publication
(10) Pub. No.: US 2014/0318149 A1
(43) Pub. Date: Oct. 30, 2014

(54) SEAL FOR A TURBOJET ENGINE PYLON AND NACELLE, AND TURBOJET ENGINE PYLON-NACELLE ASSEMBLY INCORPORATING SUCH A SEAL

(71) Applicant: AIRCELLE, Gonfreville L'Orcher (FR)

(72) Inventors: Jean-Bernard Guillon, Le Havre (FR); Alexandre Phi, Noisy-Le-Grand (FR); Stéphane Beilliard, Toulouse (FR)

(21) Appl. No.: 14/324,624

(22) Filed: Jul. 7, 2014

Related U.S. Application Data
(63) Continuation of application No. PCT/FR2013/050015, filed on Jan. 4, 2013.

(30) Foreign Application Priority Data
Jan. 5, 2012 (FR) 12/50111

(51) Int. Cl. F02C 7/28

(52) U.S. Cl. CPC F02C 7/28
USPC 60/796; 277/597

(57) ABSTRACT

A fire-resistant seal for a propulsion assembly which includes a pylon, an O-duct type nacelle of a turbojet engine. The nacelle includes an inner fixed nacelle structure and a combustion gas ejection primary nozzle, and the fire-resistant seal is placed in an annular sector defined by the inner fixed nacelle and the gas ejection primary nozzle. In particular, the fire-resistant seal includes a plurality of baffles, and the plurality of baffles are longitudinally disposed so as not to interfere each other during a longitudinal translational movement of the inner fixed nacelle structure relative to the combustion gas ejection primary nozzle.

### CROSS-REFERENCE TO RELATED APPLICATIONS

This application is a continuation of International Application No. PCT/FR2013/050015, filed on Jan. 4, 2013, which claims the benefit of FR 12/50111, filed on Jan. 5, 2012. The disclosures of the above applications are incorporated herein by reference.

### FIELD

The present disclosure relates to a seal for a pylon and a nacelle of a turbojet engine, and a turbojet engine pylon-nacelle assembly incorporating such a seal.

### BACKGROUND

The statements in this section merely provide background information related to the present disclosure and may not constitute prior art.

As it is known in the prior art, an aircraft propulsion assembly may comprise a nacelle surrounding a turbojet engine.

The upstream portion of the nacelle is intended to channel the air toward the inlet of the turbojet engine, and the downstream portion of the nacelle allows to reject at high speed the air having passed through the turbojet engine, thus allowing to generate the thrust required for the aircraft propulsion.

A nacelle typically includes one outer fairing defining the outer aerodynamic profile of the nacelle, and one inner fairing surrounding the turbojet engine, the space between these two fairings defining the cold flow path of the nacelle.

The inner fairing, often referred to as “inner fixed structure” of the nacelle, or “IFS”, is extended in its downstream portion by a combustion gas ejection primary nozzle, allowing to channel the outlet of hot air coming from the core of the turbojet engine.

In order to provide the preservation of the systems and the wing located above the turbojet engine and its nacelle, in case of an under-wing installation, it is necessary to prevent any flame, originating from a fire in a compartment inside the inner fixed structure, from coming out toward the gas ejection primary nozzle and toward the outside.

It is used in the relating art to dispose a seal between the downstream portion of the inner fixed structure and the combustion gas ejection primary nozzle.

However, there are two main kinds of means for accessing the inner members of the turbojet engine for maintenance operations.

In a first kind, the outer and inner fairings (inner fixed structure) are articulated around axes which are substantially parallel to that of the turbojet engine. When a maintenance operation has to be performed on the turbojet engine, the nacelle is open by moving apart the two half-shells formed by the two halves of the outer and inner fairings of the nacelle, and by making each one pivot around their respective longitudinal axes. The seal between the inner fixed structure and the gas ejection primary nozzle then interacts and must be designed so as to allow this axial rotation opening movement.

One example of such a seal is described in EP-A-835805. The fire-resistant seal of this prior art is disposed between the body of the gas ejection nozzle and one portion of the outer structure associated with the supporting pylon of the turbojet engine. The fire-resistant seal is composed of two plates in contact. The two plates overlap together and are delimited along their periphery by fire barriers.

In a second kind, the outer and inner fairings of the nacelle form each, or both, a one-piece annular assembly, so that access to the turbojet engine for maintenance operations is performed by sliding these fairings downstream of the nacelle, along rails disposed on the suspension pylon of the propulsion assembly formed by the nacelle and the turbojet engine.

In this case, we often refer to “O-Duct” type nacelle, such examples of nacelles being disclosed for example in FR07/03607 and FR09/05687.

For these nacelles, there is no seal between the inner fixed structure and the combustion gas ejection primary nozzle which may interact in this type of longitudinal translational movement.

### SUMMARY

The present disclosure provides a fireproof seal for a pylon-nacelle assembly of a turbojet engine, in particular of the O-duct type. This nacelle includes an inner fixed nacelle structure and a combustion gas ejection primary nozzle, movable at least for one portion, according to a relative longitudinal translational movement in the direction of the longitudinal axis of the nacelle, during maintenance operations. According to the present disclosure, the seal includes a plurality of baffles longitudinally disposed so as not to interfere during a longitudinal translational movement of the inner fixed nacelle structure and the combustion gas ejection primary nozzle.

According to other characteristics:
the seal is such that, on at least one portion of the seal, the baffles include a plurality of annular edges concentric with the longitudinal axis of the nacelle;
the seal is made of two portions, a first portion integral with the inner fixed structure and/or with said pylon and a second portion integral with the combustion gas ejection primary nozzle, one portion including a plurality of baffles which edges are intended to interpenetrate with the edges of the plurality of baffles of the other portion;
the plurality of baffles of a first portion of the seal includes two edges and the plurality of baffles of the second facing portion includes two edges;
the seal extends at least over the angular extension of an angular sector in which the risk of flame passage has been evaluated, generally +/−45° relative to the vertical.
the space between the edges of the first and the second portions of the seal is calibrated so that the fire-resistant function may be fulfilled and a light air passage is tolerated between the two portions of the seal in contact in a normal operating situation;
the materials and the dimensions of the edges and grooves constituting the seal baffles are determined so as to provide absence of contact between the edges and the bottoms of the grooves when the nacelle is in an operating situation and vibratory regimes are being established between the two portions of the seal;
a first portion of the seal is adapted to be integral with a flange of the primary ejection nozzle disposed at the outlet of the burnt gas compartment of the turbojet engine and the second portion of the seal is adapted to be integral with the downstream portion of the inner fixed nacelle structure.

The present disclosure also relates to an assembly of pylon and nacelle including an inner fixed nacelle structure and a combustion gas ejection primary nozzle, capable of adopting a longitudinal translational movement in relation to one another. The assembly includes a seal according to the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an exploded perspective view, of a turbojet engine, of its nacelle and of its pylon, of the kind used in the present disclosure;

FIG. 2 is a schematic sectional view of the portion of a nacelle surrounding the turbojet engine, equipped with the seal according to the present disclosure, in a first relative position of the inner fixed nacelle structure and the combustion gas ejection primary nozzle of the nacelle;

FIG. 3 is a schematic sectional view of the rear portion of the turbojet engine equipped with the seal according to the present disclosure, in a second relative position of the inner fixed nacelle structure and the combustion gas ejection primary nozzle of the nacelle; and

FIG. 4 is a schematic sectional view of the seal attachment according to the present disclosure, to the combustion gas ejection primary nozzle and to the inner fixed nacelle structure and to the combustion gas ejection primary nozzle of the nacelle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

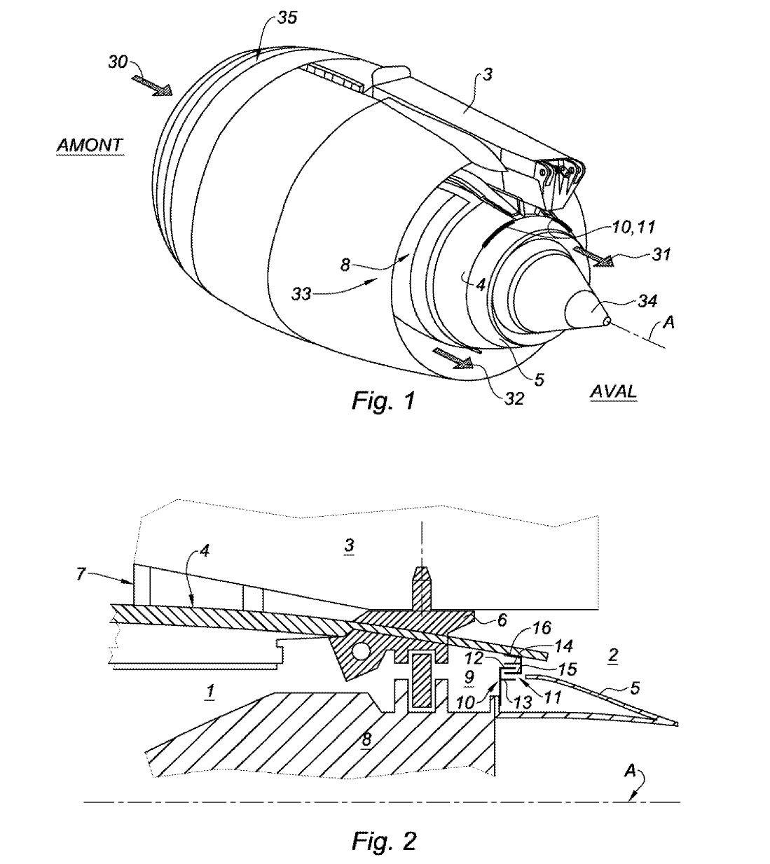

In FIG. 1, there is shown an exploded perspective view, of a turbojet engine 8, its nacelle and its pylon 3, of the kind used in the present disclosure. The propulsion assembly composed of the pylon, of the nacelle and of the turbojet engine is shown with an upstream side to the left of the drawing and a downstream side to the right of the drawing. The air represented by the arrow 30 is sucked into the air inlet 35 by the fan (not shown). A portion of the air propelled by the fan (not shown) is then emitted into the annular space forming the cold path represented by the arrow 32, between the cowl or outer fairing 33 and the inner fixed structure 4.

The fan (not shown) is driven by the core of the turbojet engine 8 which includes a combustion chamber and a turbine (not shown). Combustion gases, obtained by the combustion of fuel and air taken at the outlet of the fan are ejected by a hot path represented by the arrow 31 between the gas ejection primary nozzle 5 and the gas ejection cone 34. The assembly is constructed and installed according to a longitudinal axis A.

The pylon 3 allows to suspend the nacelle and the turbojet engine 8 to the wing of an aircraft (not shown).

The flame/fire problem takes place between the downstream edge of the inner fixed structure 4 of the nacelle and the gas ejection primary nozzle 5. According to the present disclosure, the solution is provided by means of a fire-resistant seal 10, 11 which fills at least one angular sector of the space between the downstream edge of the inner fixed structure 4 of the nacelle and the gas ejection primary nozzle 5, as will be detailed below.

In FIG. 2, there is shown the rear or downstream portion of a nacelle equipped with the seal according to the present disclosure. The rear portion 1 of the nacelle includes a combustion gas ejection primary nozzle 5 emitted by the body of the turbojet engine 8. The body of the turbojet engine 8 is mounted inside the inner fixed nacelle structure 4.

The nacelle and the engine are suspended to the pylon 3 associated with the wing of an aircraft, partially by means of the represented fasteners 6 and 7.

The fire-resistant seal 10, 11 of the present disclosure is meant to prevent the passage of flames from the downstream area 9, inside the inner fixed structure 4, to the outside.

The seal 10, 11 of the present disclosure is constituted by a plurality of baffles. In a schematic sectional view of FIG. 1, each baffle is made of a groove delimited by two annular edges concentric with the axis A of the nacelle.

Thus, in FIG. 2, a first planar groove is delimited between two concentric annular edges 12 and 13, substantially perpendicular to the plane of the first groove. A second planar groove is delimited between two concentric annular edges 14 and 15, substantially perpendicular to the plane of the first groove.

In one form, the two planes of the groove are substantially perpendicular to the longitudinal axis A of the nacelle. Therefore, the edges delimiting the grooves of the seal 10, 11 are substantially aligned in the direction of the longitudinal axis A of the nacelle. Because of the cylindrical symmetry of the nacelle around the longitudinal axis A, the edges are substantially cylinders or cylindrical arcs having a determined extension along the longitudinal axis A, while the substantially planar grooves assume the shape, at least partially, of a planar ring.

In some forms, the fire-resistant sealing is limited to one upper angular sector of about 90° around the longitudinal axis. This situation is illustrated in FIG. 1 in which the seal is symmetrically distributed in the upper sector on both sides of the vertical plane separating the propulsion assembly into two substantially symmetrical halves. In these forms, the seal extends at least over the angular extension of the angular sector of the space 2 between the combustion gas ejection primary nozzle 5 and the downstream space of the inner fixed nacelle structure 4 in which the risk of flames passage has been evaluated.

In one form, the baffles of the seal of the present disclosure are distributed into two distinct portions of the seal. A first portion 10 of the seal is attached to one determined portion of the combustion gas ejection nozzle 5 while a second portion 11 of the seal is attached to a determined portion downstream 9 of the inner fixed nacelle structure 4.

In FIG. 2, the turbojet engine 1 is configured for normal operation. The seal 10, 11 is hence in “closed” state, in the sense that the two portions are joined for a sealing interaction. The edges 12, 13 of the groove of the first portion 10 of the seal are interdigitated with the facing edges 14 and 15 of the groove of the second portion 11 of the seal. The second portion 11 of the seal further includes an integral part 16 which is attached by a suitable mean on the inner face of the downstream portion 9 of the inner fixed nacelle structure 4.

The space between the edges of the first and the second portions of the seal is calibrated so that the fire-resistant function may be fulfilled. It is further noted that a light air passage is tolerated between the two portions 10 and 11 of the seal in contact in a normal operating situation.

Typically, such a seal may be made of fire-resistant metallic materials such as titanium or Inconel.

In addition, the materials and the dimensions of the edges and grooves constituting the seal baffles are determined so as to provide absence of contact between the edges and the bottoms of the grooves when the nacelle is in an operating situation and vibratory regimes are being established between the two portions 10 and 11 of the seal.

Particularly, the absence of contact between the two portions 10 and 11 of the seal provides a little or no wear, an absence of vibrations transmission and an improved durability over the seals of the prior art.

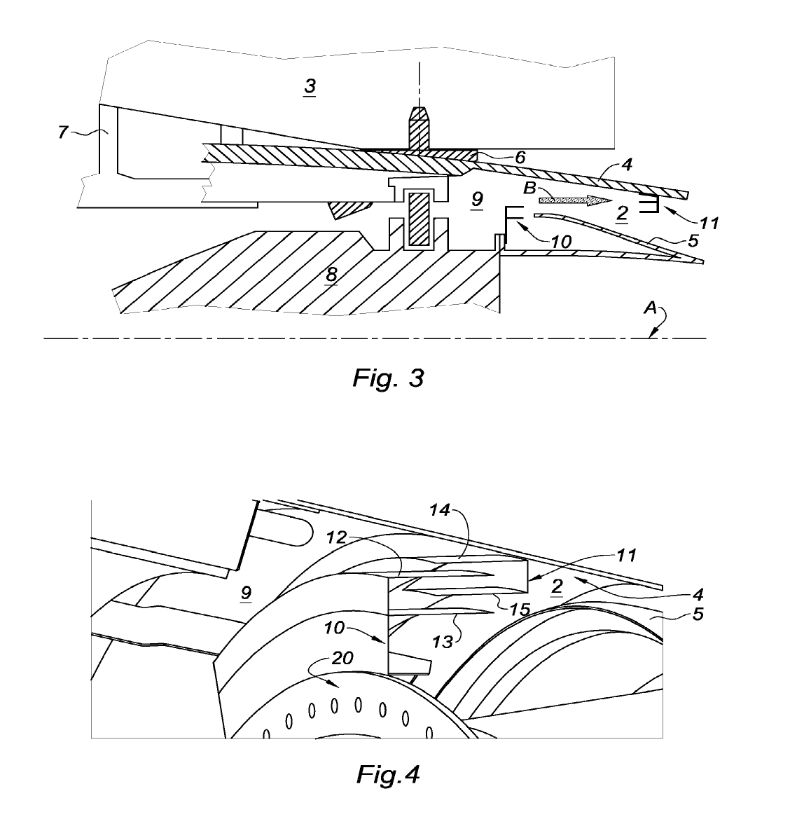

In FIG. 3, there is shown a schematic sectional view of the rear portion of the turbojet engine equipped with the seal according to the present disclosure, in a second relative position of the inner fixed nacelle structure and the combustion gas ejection primary nozzle 5. In FIG. 3, the portions identical to those of FIGS. 1 and 3 have the same reference numeral and will not necessarily be described again.

In the configuration shown in this FIG. 3 corresponding to a maintenance situation of the turbojet engine, the inner fixed nacelle structure 4 is longitudinally displaced to the rear or downstream of the turbojet engine, substantially according to the arrow B aligned on the longitudinal axis A of the nacelle.

In this state, the seal 10, 11 is mechanically dissociated into its two portions, respectively the portion 10 on the combustion gas ejection primary nozzle and the portion 11 on a downstream portion of the nacelle fixed structure 11. The seal 10, 11 is hence in an “open” state, in the sense that the two portions of the seal are disjoined and the sealing is removed.

The absence of contact between the facing portions of the seal provides an easy and natural disassembling, and the absence of deformation or deterioration of the seal during the position changes, from the “closed” to “open” states or from the “open” to the “closed” states.

In FIG. 4, there is shown a schematic sectional view of the seal attachment according to the present disclosure, to the combustion gas ejection primary nozzle 5 and to the inner fixed nacelle structure. The view is partially a three dimensional representation.

The first portion 10 of the seal is attached by suitable means on a flange 20 which extends in form of a disc ring disposed in a plane normal to the longitudinal axis A of the nacelle. The flange 20 is a portion of the combustion gas ejection primary nozzle 5 allowing the attachment of this nozzle to the body 8 of the turbojet engine.

The second portion 11 of the seal is attached by suitable means to one facing portion which is located downstream of the nacelle fixed structure 4.

The seal of the present disclosure may take various forms. Particularly, the number of baffles is not limited and more than two edges and one groove may be provided on each portion of the seal. The shape of the edges and the groove may be variable while maintaining the absence of contact on the one hand, and the absence of interaction during the relative longitudinal translation of the inner fixed nacelle structure 4 and the combustion gases ejection primary nozzle 5 on the other hand.

Of course, the present disclosure is not limited to the form described and shown, provided as a simple example.

Thus, one might for instance extend the concept of the present disclosure to every nacelle in which the inner fixed structure may slide for maintenance operations, including a nacelle in which the outer fairing does not form one-piece with the inner fixed structure, and opens outwards in two halves each pivoting around a longitudinal axis.

Thus, one might also consider that the seal according to the present disclosure is disposed between the pylon 3 and the combustion gas ejection primary nozzle 5.

What is claimed is:

1. A fire-resistant seal for a propulsion assembly, the propulsion assembly comprising a pylon, an O-duct type nacelle of a turbojet engine, the nacelle comprising an inner fixed nacelle structure and a combustion gas ejection primary nozzle,
wherein the fire-resistant seal is placed in an annular sector defined by the inner fixed nacelle and the gas ejection primary nozzle, the fire-resistant seal comprising a plurality of baffles,
wherein the inner fixed nacelle structure is configured to translate in a direction of a longitudinal axis of the nacelle, and the plurality of baffles are longitudinally disposed so as not to interfere each other during a longitudinal translational movement of the inner fixed nacelle structure relative to the combustion gas ejection primary nozzle.

2. The fire-resistant seal according to claim 1, wherein on at least one portion of the fire-resistant seal, the plurality of baffles include an annular edge concentric with the longitudinal axis of the nacelle.

3. The fire-resistant seal according to claim 2, wherein the fire-resistant seal is made of first and second portions, the first portion integral with the inner fixed nacelle structure and/or with said pylon, and the second portion integral with the combustion gas ejection primary nozzle, wherein an edge of the plurality of baffles of the first portion penetrates into a corresponding groove formed by edges of the plurality of baffles of the second portion.

4. The fire-resistant seal according to claim 3, wherein the plurality of baffles of the first and second portions of the fire-resistant seal comprise at least two edges.

5. The fire-resistant seal according to claim 1, wherein the fire-resistant seal extends at least over an angular extension of the angular sector in which a risk of flame passage has been evaluated about +/−45° relative to a vertical.

6. The seal according to claim 4, wherein the space between the edges of the plurality baffles of the first and the second portions is calibrated to perform a fire-resistant function, and a light air passage is tolerated between the first and second portions in a normal operating situation.

7. The seal according to claim 4, wherein materials and dimensions of edges and a groove formed by the edges constituting the plurality of baffles of the first portion are determined so as to provide an absence of a contact with a corresponding the edges and a bottom of the grooves of the second portion when the nacelle is in an operating situation, and vibratory regimes are being established between the first and second portions of the fire-resistant seal.

8. The seal according to claim 2, wherein the fire-resistant seal is made of first and second portions, the first portion of the fire-resistant seal is adapted to be integral with a flange of the combustion gas ejection primary nozzle disposed at an outlet of a burnt gas compartment of the turbojet engine, and the second portion of the fire-resistant seal is adapted to be integral with a downstream portion of the inner fixed nacelle structure.

9. A pylon-nacelle assembly including a combustion gas ejection primary nozzle and an inner fixed nacelle structure capable of adopting a longitudinal translational movement in relation to one another, comprising the fire-resistant seal according to claim 1.
